(19) United States
(12) Patent Application Publication
(10) Pub. No.: US 2020/0373616 A1
(43) Pub. Date: Nov. 26, 2020

(54) LITHIUM SECONDARY BATTERY

(71) Applicant: SAMSUNG SDI CO., LTD., Yongin-si, Gyeonggi-do (KR)

(72) Inventors: Seonju CHOI, Yongin-si, Gyeonggi-do (KR); Kyoung Soo KIM, Yongin-si, Gyeonggi-do (KR); Yunhee KIM, Yongin-si, Gyeonggi-do (KR); Yongchan YOU, Yongin-si, Gyeonggi-do (KR); Erang CHO, Yongin-si, Gyeonggi-do (KR)

(21) Appl. No.: 16/638,522

(22) PCT Filed: Aug. 1, 2018
(86) PCT No.: PCT/KR2018/008758

§ 371 Date: Feb. 12, 2020

(30) Foreign Application Priority Data
Sep. 6, 2017 (KR) 10-2017-0113936

(51) Int. Cl. H01M 10/0567; H01M 4/525; H01M 4/505; H01M 10/0525; H01M 10/0568

(52) U.S. Cl. CPC H01M 10/0567; H01M 4/525; H01M 2300/0025; H01M 10/0525; H01M 10/0568; H01M 4/505

(57) ABSTRACT

A lithium secondary battery is disclosed. The lithium secondary battery according to an embodiment comprises: an anode; a cathode comprising a cathode active material; and a nonaqueous electrolyte, wherein the nonaqueous electrolyte comprises a nonaqueous organic solvent, a lithium salt, a first additive comprising at least one of compounds represented by chemical formulae 1-4, and a second additive comprising at least one of compounds represented by chemical formulae 5 to 6, and the cathode active material can comprise a compound containing 60 mol % or greater of Ni.

### TECHNICAL FIELD

The present disclosure relates to a lithium secondary battery.

### BACKGROUND ART

A portable information device such as a cell phone, a laptop, smart phone, and the like or an electric vehicle has used a lithium secondary battery having high energy density and easy portability as a driving power source.

In general, a lithium secondary battery is manufactured by using materials capable of reversibly intercalating and deintercalating lithium ions as a cathode active material and an anode active material and filling an electrolyte between a cathode and an anode.

Herein, lithium-transition metal oxides are used as the cathode active material of the lithium secondary battery, various types of carbon-based materials are used as the anode active material, and lithium salts dissolved in the non-aqueous organic solvent are used as an electrolyte.

In particular, a lithium secondary battery exhibits battery characteristics by complex reactions such as a cathode and an electrolyte, an anode and an electrolyte, and the like and thus, the use of a suitable combination is one of important parameters for improving the performance of a lithium secondary battery.

### DISCLOSURE

### Technical Problem

An embodiment provides a lithium secondary battery having improved resistance characteristics at room temperature and high temperature.

### Technical Solution

In one aspect, the present disclosure provides a lithium secondary battery including an anode, a cathode including a cathode active material, and a non-aqueous electrolyte, wherein the non-aqueous electrolyte includes a non-aqueous organic solvent, a lithium salt, a first additive including at least one of compounds represented by Chemical Formulae 1 to 4, and a second additive including at least one of compounds represented by Chemical Formulae 5 to 6, and the cathode active material includes a compound including 60 mol % or greater of Ni.

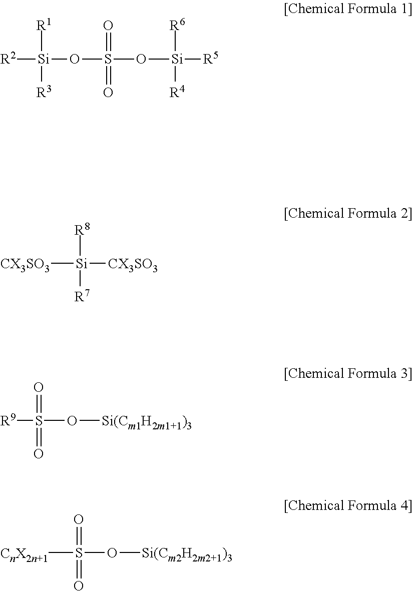

In Chemical Formulae 1 to 4,

R¹ to R⁹ are independently a primary, secondary, or tertiary alkyl group, an alkenyl group, or an aryl group, X is hydrogen or a halogen atom,

n is an integer of 0 to 3, and

m1 and m2 are independently an integer of 0 to 3.

Li_{α}PO₃F_{β} [Chemical Formula 5]

Li_{γ}PO₂F₆ [Chemical Formula 6]

### In Chemical Formulae 5 and 6,

α and γ are independently an integer of 1 or more, β and δ are independently an integer of 0 or more, α+β≤3, and γ+δ≤3.

### Advantageous Effects

According to an embodiment of the present disclosure, a lithium secondary battery having improved resistance characteristics at room temperature and high temperature may be implemented.

### DESCRIPTION OF THE DRAWINGS

FIG. 1 schematically shows a lithium secondary battery according to an embodiment of the present disclosure.

### MODE FOR INVENTION

Hereinafter, various embodiments of the present invention will be described in detail with reference to the accompanying drawings so that those skilled in the art may easily carry out the present invention. However, this disclosure may be embodied in many different forms and is not construed as limited to the example embodiments set forth herein.

In order to clearly illustrate the present invention, parts that are not related to the description are omitted, and the same or similar components are denoted by the same reference numerals throughout the specification.

The size and thickness of each constituent element as shown in the drawings are randomly indicated for better understanding and ease of description, and the present invention is not necessarily limited to as shown.

In addition, unless explicitly described to the contrary, the word “comprise” and variations such as “comprises” or “comprising,” will be understood to imply the inclusion of stated elements but not the exclusion of any other elements.

A lithium secondary battery according to an embodiment of the present disclosure includes a cathode, an anode, and a non-aqueous electrolyte.

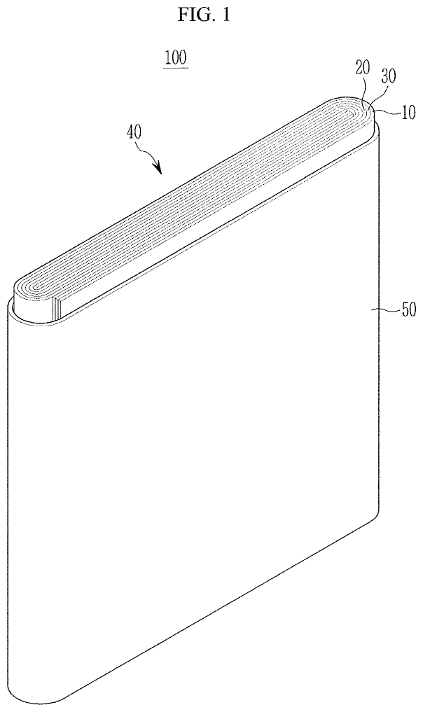

Hereinafter, a lithium secondary battery according to an embodiment is described with reference to FIG. 1.

FIG. 1 is a schematic view of a lithium secondary battery according to an embodiment of the present disclosure.

Referring to FIG. 1, a lithium secondary battery 100 according to an embodiment of the present disclosure includes an electrode assembly 40 and a case 50 housing the same.

The electrode assembly 40 may include a cathode 10, an anode 20, a separator 30 disposed between the cathode 10 and the anode 20, and a non-aqueous electrolyte (not shown) impregnating the cathode 10, anode 20, and separator 30.

In the present disclosure, the non-aqueous electrolyte includes a non-aqueous organic solvent, a lithium salt, a first additive including at least one of compounds represented by Chemical Formulae 1 to 4, and a second additive including at least one of compounds represented by Chemical Formulae 5 to 6.

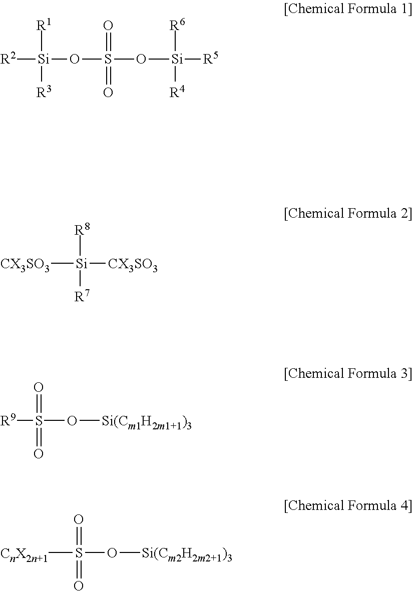

In Chemical Formulae to 4, R¹ to R⁹ are independently a primary, secondary, or tertiary alkyl group, an alkenyl group, or an aryl group, X is hydrogen or a halogen atom, n is an integer of 0 to 3, and m1 and m2 are independently an integer of 0 to 3.

The alkyl group may be a C1 to C9 alkyl group, the alkenyl group may be a C2 to C9 alkenyl group, and the aryl group may be a C6 to C12 aryl group. In addition, the alkyl, alkenyl, or aryl group may be substituted with a halogen atom such as F and a cyano group.

The halogen atom may be at least one selected from F, Cl, Br, I, and a combination.

Li_{α}PO₃F_{β} [Chemical Formula 5]

Li_{γ}PO₂F_{δ} [Chemical Formula 6]

In Chemical Formulae 5 and 6, α and γ are independently an integer of 1 or more, β and δ are independently an integer of 0 or more, α+β≤3, and γ+δ≤3.

More specifically, the first additive may be, for example, one or more selected from bis(triethylsilyl) sulfate, bis(trimethylsilyl) sulfate, di-t-butylsilyl bis(trifluoromethanesulfonate), trimethylsilyl methane sulfonate, trimethylsilyl ethane sulfonate, triethylsilyl methane sulfonate, trimethylsilyl benzene sulfonate, trimethylsilyl trifluoromethane sulfonate, triethylsilyl trifluoromethane sulfonate, and a combination thereof.

The second additive may be, for example, at least one selected from LiPO₂F₂, LiPO₃F₂, and a combination thereof.

The non-aqueous electrolyte of the present embodiment uses the compound represented by Chemical Formula 1 as the first additive and the compound represented by Chemical Formula 5 as the second additive and thus may more effectively realize a lithium secondary battery having an improved room-temperature cycle-life and high-temperature storage characteristics.

On the other hand, the first additive may be used in an amount of 0.05 wt % to 10 wt %, specifically, 0.2 wt % to 6 wt %, or 0.2 wt % to 3 wt % based on a total weight of the electrolyte. As the content of the first additive satisfies the range, conductivity of lithium ions in the lithium secondary battery may be maintained and simultaneously, cell performance at a high temperature may be improved. In addition, there may be an effect of improving the resistance performance and thus, an output maintenance rate.

An amount of the second additive may be 0.05 wt % to 15 wt % and specifically, 0.2 wt % to 5 wt % based on a total weight of the electrolyte. When the amount of the second additive satisfies the range, the lithium ion conductivity in the lithium secondary battery may be maintained, and simultaneously, the battery performance at a high temperature may be improved. In addition, there may be an effect of improving the resistance performance and thus, the output maintenance rate.

On the other hand, the non-aqueous organic solvent serves as a medium for transporting ions taking part in the electrochemical reaction of a battery.

The non-aqueous organic solvent may be a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like and the ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran and the like, and the ketone-based solvent may be cyclohexanone, and the like. The alcohol-based solvent may include ethanol, isopropyl alcohol, and the like, and the aprotic solvent may include nitriles such as R—CN (wherein R is a C2 to C20 linear, branched, or cyclic hydrocarbon group, a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used alone or in a mixture. When the organic solvent is used in a mixture, the mixing ratio may be controlled in accordance with a desirable battery performance.

When the non-aqueous organic solvent is used in a mixture, a mixed solvent of cyclic carbonate and chain carbonate a mixed solvent of cyclic carbonate and a propionate based solvent, or a mixed solvent of cyclic carbonate, chain carbonate, and a propionate based solvent. The propionate based solvent may be methylpropionate, ethylpropionate, propylpropionate, or a combination thereof.

Herein, when the cyclic carbonate and the linear carbonate or the cyclic carbonate and the propionate based solvent are mixed, they may be mixed in a volume ratio of 1:1 to 1:9 and thus performance of an electrolyte solution may be improved. In addition, when the cyclic carbonate, the linear carbonate, and the propionate based solvent are mixed, they may be mixed in a volume ratio of 1:1:1 to 3:3:4. The mixing ratios of the solvents may be appropriately adjusted according to desirable properties.

The non-aqueous organic solvent of this disclosure may further include an aromatic hydrocarbon-based organic solvent in addition to the carbonate based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 3.

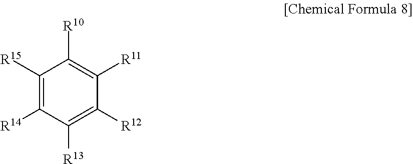

In Chemical Formula 8, R¹⁰ to R¹⁵ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate or an ethylene carbonate-based compound of Chemical Formula 9 in order to improve battery cycle-life.

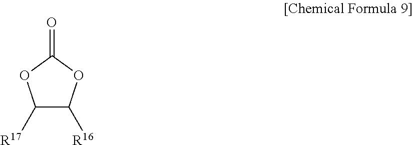

In Chemical Formula 9, R¹⁶ and R¹⁷ are the same or different, and selected from hydrogen, a halogen, a cyano group (CN), a nitro group (NO₂), a fluorinated C1 to C5 alkyl group, provided that at least one of R¹⁶ and R¹⁷ is selected from a halogen, a cyano group (CN), a nitro group (NO₂), and a fluorinated C1 to C5 alkyl group and R¹⁶ and R¹⁷ are not all hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. When the additive for improving the cycle-life is further used, its use amount may be adjusted appropriately.

The lithium salt dissolved in the organic solvent may act as a source of lithium ion in the battery, enabling a basic operation of a lithium secondary battery and promoting the movement of lithium ions between the cathode and anode. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAO₂, LiAlCl₄, LiN(CₓF₂ₓ₊₁SO₂)(C_{y}F_{2y+1}SO₂), where x and y are natural numbers, LiCl, LiI, and LiB(C₂O₄)₂ (lithium bis(oxalato) borate; LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Next, the cathode 10 is described.

The cathode 10 includes a cathode active material layer disposed on the cathode current collector. The cathode active material layer includes a cathode active material and may include the aforementioned cathode active material for a lithium secondary battery according to the embodiment as the cathode active material.

Herein, the cathode active material may include a compound including 60 mol % or greater of Ni.

Specifically, the compound including 60 mol % or greater of Ni may be represented by Chemical Formula 7.

LiₐNiₓCo_{y}Me_{z}O₂ [Chemical Formula 7]

In Chemical Formula 7, 0.9≤a≤1.1, 0.6≤x≤0.98, 0<y≤0.3, 0<z≤0.3, x+y+z=1, and Me is Mn or Al.

The compound represented by Chemical Formula 7 may have a high nickel content, that is, x may be 0.6 to 0.98. In this way, when a cathode active material including the compound having a high nickel content is used, a lithium secondary battery having high capacity may be manufactured. In other words, when x is less than 0.6, a lithium secondary battery showing very high capacity may be realized, compared with a lithium secondary battery using a compound having a low nickel content as a cathode active material.

The compound represented by Chemical Formula 7 may be, for example, prepared by mixing a lithium-containing compound, a nickel-containing compound, a cobalt-containing compound, and an Me-containing compound.

The lithium-containing compound may be, for example, lithium acetate, lithium nitrate, lithium hydroxide, lithium carbonate, lithium acetate, a hydrate thereof, or a combination thereof. The nickel-containing compound may be, for example, nickel nitrate, nickel hydroxide, nickel carbonate, nickel acetate, nickel sulfate, a hydrate thereof, or a combination thereof. In addition, the cobalt-containing compound may be, for example, cobalt nitrate, cobalt hydroxide, cobalt carbonate, cobalt acetate, cobalt sulfate, a hydrate thereof, or a combination thereof. The Me-containing compound may be, for example, Me-containing nitrate, Me-containing hydroxide, Me-containing carbonate, Me-containing acetate, Me-containing sulfate, a hydrate thereof, or a combination thereof. Herein, a mixing ratio of the lithium-containing compound, the nickel-containing compound, the cobalt-containing compound, and the Me-containing compound may be properly adjusted to obtain the compound of Chemical Formula 7.

Meanwhile, in the cathode active material layer, an amount of the cathode active material may be 90 wt % to 98 wt % based on the total weight of the cathode active material layer.

In embodiments, as a cathode active material, a cathode active material including two or more compounds represented by different chemical formulae may be applied. Specifically, a cathode active material including both of a compound including Ni, Co, and Mn and a compound including Ni, Co, and Al may be applied. Alternatively, a cathode active material prepared by mixing a compound including no nickel and a compound including Ni, Co, and Mn, or a compound including Ni, Co, and Al may be applied.

Herein, when one of the two or more compounds is the compound represented by Chemical Formula 7, the compound represented by Chemical Formula 7 may be included in an amount of 30 wt % to 97 wt % based on a total amount of the cathode active material.

In an embodiment of the present disclosure, the cathode active material layer may further include a binder and a conductive material. Herein, each amount of the binder and the conductive material may be 1 wt % to 5 wt % based on the total weight of the cathode active material layer.

The binder acts to adhere the cathode active material particles to each other well, and also serves to adhere the cathode active material to the current collector well. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to provide electrode conductivity and any electrically conductive material may be used as a conductive material unless it causes a chemical change. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The cathode current collector may be an aluminum foil, a nickel foil, or a combination thereof, but is not limited thereto.

Next, the anode 20 includes an anode current collector and an anode active material layer disposed on the current collector. The anode active material layer includes an anode active material.

The anode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon material that is a generally-used carbon-based anode active material in a lithium secondary battery. Examples of the carbon-based anode active material may be crystalline carbon, amorphous carbon, or a mixture thereof. The crystalline carbon may be unspecified shape, or sheet, flake, spherical, or fiber shaped natural graphite or artificial graphite. The amorphous carbon may be a soft carbon, a hard carbon, a mesophase pitch carbonization product, fired coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a silicon-based material, for example, Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and not Si), a Si-carbon composite, Sn, SnO₂, Sn—R (wherein R is an element selected from an alkali metal, an alkaline-earth metal, a Group 13 element, a Group 14 element, a Group 15 element, a Group 16 element, a transition metal, a rare earth element, and a combination thereof, and not Sn), a Sn-carbon composite, and the like and at least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb. Bi. S, Se, Te, Po, and a combination thereof.

The transition metal oxide may include a lithium titanium oxide.

In the anode active material layer, the anode active material may be included in an amount of 95 wt % to 99 wt % based on the total weight of the anode active material layer.

In an embodiment, the anode active material may be a silicon-carbon composite including, for example, crystalline carbon and silicon particles. In this case, the average diameter (D50) of the silicon particles included in the silicon-carbon composite may be in the range of 10 nm to 200 nm. In addition, at least one part of the silicon-carbon composite may include an amorphous carbon layer. Unless otherwise defined herein, the average diameter (D50) of the particles refers to a diameter of the particles having a cumulative volume of 50% by volume in the particle size distribution.

According to another embodiment, the anode active material may be used by mixing two or more types of anode electrode active material. For example, the first anode active material may include a silicon-carbon composite and the second anode active material may include crystalline carbon.

In the case of mixing two or more anode active materials as anode active materials, a mixing ratio thereof may be appropriately adjusted, but it is desirable to adjust the amount of Si to 3 wt % to 50 wt % based on a total weight of the anode active material.

In addition, when using two or more anode active materials, the anode may include a second anode active material layer including a second anode active material which is formed on a first anode active material layer including the first anode active material. Alternatively, a single anode active material layer may be formed by mixing the first anode active material and the second anode active material in an appropriate ratio.

The anode active material layer may include an anode active material and a binder, and may optionally further include a conductive material.

In the anode active material layer, the anode active material may be included in an amount of 95 wt % to 99 wt % based on the total weight of the anode active material layer. In the anode active material layer, an amount of the binder may be 1 wt % to 5 wt % based on a total weight of the anode active material layer. When the conductive material is further included, 90 wt % to 98 wt % of the anode active material, 1 wt % to 5 wt % of the binder, and 1 wt % to 5 wt % of the conductive material may be used.

The binder acts to adhere anode active material particles to each other and to adhere the anode active material to the current collector. The binder may use a non-water-soluble binder, a water-soluble binder, or a combination thereof.

The non-water-soluble binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the anode binder is a water-soluble binder, a cellulose-based compound may be further used to provide viscosity as a thickener. The cellulose-based compound includes one or more of carboxymethyl cellulose, hydroxypropylmethyl cellulose, methyl cellulose, or alkali metal salts thereof. The alkali metals may be Na, K, or Li. The thickener may be included in an amount of 0.1 parts by weight to 3 parts by weight based on 100 parts by weight of the anode active material.

The conductive material is included to provide electrode conductivity and any electrically conductive material may be used as a conductive material unless it causes a chemical change. Examples of the conductive material include a carbon-based material such as natural graphite, artificial graphite, carbon black, acetylene black, ketjen black, denka black, a carbon fiber, and the like; a metal-based material of a metal powder or a metal fiber including copper, nickel, aluminum silver, and the like; a conductive polymer such as a polyphenylene derivative; or a mixture thereof.

The anode current collector may include one selected from a copper foil, a nickel foil, a stainless steel foil, a titanium foil, a nickel foam, a copper foam, a polymer substrate coated with a conductive metal, and a combination thereof.

On the other hand, the electrode assembly 40, as shown in FIG. 1, may have a structure obtained by interposing a separator 30 between band-shaped cathode 10 and anode 20, spirally winding them, and compressing it into flat. In addition, even though not shown, a plurality of quadrangular sheet-shaped cathode and anode may be alternately stacked with a plurality of separator therebetween.

The separator 30 may be any generally-used separator in a lithium battery which can separate a cathode 10 and an anode 20 and provide a transporting passage for lithium ions. In other words, it may have low resistance to ion transport and excellent impregnation for an electrolyte. The separator 13 may be, for example, selected from a glass fiber, polyester, polyethylene, polypropylene, polytetrafluoroethylene, or a combination thereof. It may have a form of a non-woven fabric or a woven fabric. For example, in a lithium secondary battery, a polyolefin-based polymer separator such as polyethylene and polypropylene is mainly used, in order to ensure the heat resistance or mechanical strength, a coated separator including a ceramic component or a polymer material may be used, and optionally, it may have a mono-layered or multi-layered structure.

As described above, a non-aqueous electrolyte including first and second additives and a cathode formed of an cathode active material including a compound including greater than or equal to 60 mol % of Ni may be used to realize a lithium secondary battery having remarkably improved room temperature and high temperature cycle-life characteristics.

Meanwhile, the lithium secondary battery according to an embodiment may be included in a device including at least one of the same. Such a device may be for example, one of a mobile phone, a tablet computer, a laptop computer, a power tool, a wearable electronic device, an electric vehicle, a hybrid electric vehicle, a plug-in hybrid electric vehicle, and a power storage device. In this way, the device to which the lithium secondary battery is applied is well known in a related art and thus will not be specifically illustrated in the present specification.

### EXAMPLES FOR PERFORMING INVENTION

Hereinafter, the specification will be specifically examined through Examples.

### Examples 1 to 8 and Comparative Examples 1 to 9

### (1) Preparation of Non-Aqueous Electrolytes

Non-aqueous electrolytes for a lithium secondary battery were prepared by adding 1.15 M LiPF₆ to a mixed solvent of ethylene carbonate, ethylmethyl carbonate, and dimethyl carbonate (in a volume ratio of 20:40:40) and then, first and second additives to 100 wt % of the obtained mixture in a composition shown in Table 1.

### (2) Manufacture of Lithium Secondary Battery Cell

The non-aqueous electrolyte prepared in (1), a cathode, and an anode were used to manufacture a cylindrical lithium secondary battery cell in a common method. Herein, 3 g of an electrolyte was injected theretinto.

The cathode was manufactured by mixing 96 wt % of a cathode active material, 2 wt % of a ketjen black conductive material, and 2 wt % of polyvinylidene fluoride according to a composition shown in Table 1 in an N-methylpyrrolidone solvent to prepare cathode active material slurry, coating the cathode active material slurry on an aluminum foil, and then, drying and compressing it.

The anode was manufactured by mixing 96 wt % of an artificial graphite anode active material, 2 wt % of a ketjen black conductive material, and 2 wt % of polyvinylidene fluoride in an N-methylpyrrolidone solvent to prepare anode active material slurry, coating the anode active material slurry on a copper foil, and then, drying and compressing it.

### Experimental Examples

Resistance variation rates of the lithium secondary battery cells of Examples 1 to 8 and Comparative Examples 1 to 9 at a high temperature were measured, and the results are shown in Table 1.

The resistance variation rates at a high temperature were measured by storing the lithium secondary battery cells at 60° C. for 30 days and then, measuring resistances thereof before and after the storage.

In addition, the lithium secondary battery cells of Examples 1 to 8 and Comparative Examples 1 to 9 were 300 times charged and discharged at room temperature of 25° C. at 1C, and then, the resistance variation rates thereof were measured, and the results are shown in Table 1.

TABLE 1

| | | | | Second | Resistance | Resistance |
|---|---|---|---|---|---|---|
| | Positive | First additive | | additive | variation rate | variation rate |
| | active | (wt %) | | (wt %) | at room | after 60° C. |
| | material | TESS | TESMS | LiPO₂F₂ | temperature | storage |
| Example 1 | Ni88 | 0.5 | | 1 | 137 | 131 |
| Example 2 | Ni88 | 1 | | 1 | 130 | 122 |
| Example 3 | Ni88 | 1.5 | | 1 | 134 | 120 |
| Example 4 | Ni60 | 0.5 | | 1 | 125 | 124 |
| Example 5 | Ni60 | 1 | | 1 | 121 | 115 |
| Example 6 | Ni60 | 1.5 | | 1 | 122 | 112 |
| Example 7 | Ni88 | | 1 | 1 | 129 | 124 |
| Example 8 | Ni60 | | 1 | 1 | 122 | 115 |
| Comparative | Ni88 | 1 | | 0 | 155 | 137 |
| Example 1 | | | | | | |
| Comparative | Ni88 | 7 | | 1 | 152 | 148 |
| Example 2 | | | | | | |
| Comparative | Ni60 | 2 | | 0 | 141 | 136 |
| Example 3 | | | | | | |
| Comparative | LCO | 7 | | 0 | 151 | 149 |
| Example 4 | | | | | | |
| Comparative | LCO | 7 | | 1 | 152 | 142 |
| Example 5 | | | | | | |
| Comparative | Ni50 | 7 | | 1 | 143 | 139 |
| Example 6 | | | | | | |
| Comparative | Ni33 | 7 | | 1 | 140 | 135 |
| Example 7 | | | | | | |
| Comparative | Ni50 | 7 | | 0 | 148 | 141 |
| Example 8 | | | | | | |
| Comparative | Ni33 | 7 | | 0 | 145 | 135 |
| Example 9 | | | | | | |

In Table 1, the cathode active material compositions and each compound marked as the first and second additives are as follows.

Ni60:LiNi_{0.6}Co_{0.2}Mn_{0.2}O₂

Ni50:LiNi_{0.5}Co_{0.2}Mn_{0.3}O₂

Ni33:LiNi_{0.33}Co_{0.33}Mn_{0.33}O₂

LCO:LiCoO₂

Ni88:LiNi_{0.88}Co_{0.105}Al_{0.015}O₂

TESS: bis(triethylsilyl sulfate (Chemical Formula 1a)

TMSES: trimethylsilyl ethane sulfonate (Chemical Formula 3a)

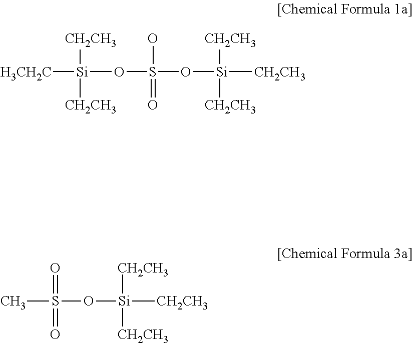

As shown in Table 1, the lithium secondary battery cells of Examples 1 to 8 manufactured by applying a nickel-based cathode active material having a Ni content of greater than or equal to 60 mol % as a cathode active material and an electrolyte including at least one of the compounds represented by Chemical Formulae 1 to 4 as the first additive and at least one of the compounds represented by Chemical Formulae 5 to 6 as the second additive exhibited a very low resistance variation rate at room temperature and a high temperature. The lithium secondary battery cells of Examples 2, 5, 7, and 8 exhibited a low room temperature resistance variation rate.

On the contrary, the lithium secondary battery cells of Comparative Examples 1 and 3 using the same cathode active material as the one used in Examples but the first additive alone and the lithium secondary battery cell of Comparative Example 2 using the same cathode active material as the one used in Examples and including both of the first and second additives but the first additive in an excessive amount exhibited very high resistance variation rates at both of room temperature and a high temperature.

In addition, Comparative Examples 4 and 5 using a compound including no Ni as a cathode active material exhibited very high resistance variation rates at room temperature and a high temperature, compared with Examples.

Comparative Examples 6 to 9 having the same cathode active material composition as those of Examples but using the Ni content of less than 60 mol % exhibited a very high resistance variation rate compared with Examples.

Resultantly, as shown in Examples, when a nickel-based cathode active material having a high Ni content mole ratio of 60 mol % was used as a cathode active material, and simultaneously, at least one of the compounds represented by Chemical Formulae 1 to 4 was used as the first additive, and at least one of the compounds represented by Chemical Formulae 5 to 6 was used as the second additive, resistance characteristics at room temperature and a high temperature were greatly improved.

While this invention has been described in connection with what is presently considered to be drawings, it is to be understood that the invention is not limited to the disclosed embodiments, and it is intended to cover various modifications and equivalent arrangements included within scope which may be ready obtained from the examples to one of ordinary skill in the arts.

### DESCRIPTION OF SYMBOLS

100: lithium secondary battery
10: cathode
20: anode
30: separator
50: case

1. A lithium secondary battery comprising
an anode;
a cathode comprising a cathode active material; and
a non-aqueous electrolyte,
wherein the non-aqueous electrolyte comprises
a non-aqueous organic solvent, a lithium salt, a first additive comprising at least one of compounds represented by Chemical Formulae 1 to 4 and a second additive comprising at least one of compounds represented by Chemical Formulae 5 to 6,
the cathode active material comprises
a compound comprising 60 mol % or greater of Ni: 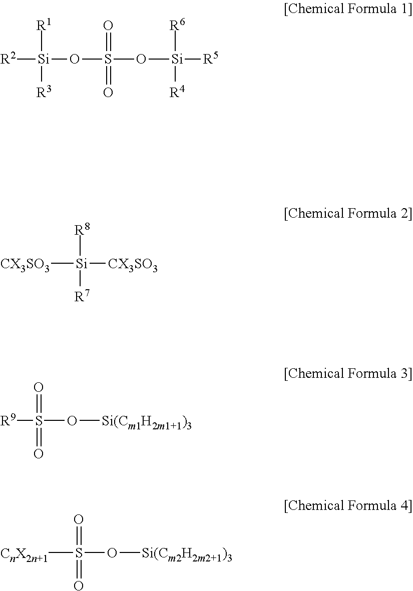
wherein, in Chemical Formulae 1 to 4,
R¹ to R⁹ are independently a primary, secondary, or tertiary alkyl group, an alkenyl group, or an aryl group, X is hydrogen or a halogen atom,
n is an integer of 0 to 3, and
m1 and m2 are independently an integer of 0 to 3,
Li_{α}PO₃F_{β} [Chemical Formula 5]
Li_{γ}PO₂F_{δ} [Chemical Formula 6]
wherein, in Chemical Formulae 5 and 6,
α and γ are independently an integer of 1 or more, β and δ are independently an integer of 0 or more, α+β≤3, and γ+δ≤3.

2. The lithium secondary battery of claim 1, wherein an amount of the first additive is 0.05 wt % to 10 wt % based on a total weight of the electrolyte.

3. The lithium secondary battery of claim 1, wherein an amount of the first additive is 0.2 wt % to 3 wt % based on a total weight of the electrolyte.

4. The lithium secondary battery of claim 1, wherein an amount of the second additive is 0.05 wt % to 15 wt % based on a total weight of the electrolyte.

5. The lithium secondary battery of claim 1, wherein an amount of the second additive is 0.2 wt % to 5 wt % based on a total weight of the electrolyte.

6. The lithium secondary battery of claim 1, wherein the first additive is at least one selected from bis(triethylsilyl) sulfate, bis(trimethylsilyl) sulfate, di-t-butylsilylbis(trifluoromethanesulfonate), trimethylsilyl methane sulfonate, trimethylsilyl ethanesulfonate, triethylsilyl methanesulfonate, trimethylsilyl benzene sulfonate, trimethylsilyl trifluoromethane sulfonate, triethylsilyl trifluoromethane sulfonate, and a combination thereof.

7. The lithium secondary battery of claim 1, wherein the second additive is at least one selected from LiPO₂F₂, LiPO₃F₂, and a combination thereof.

8. The lithium secondary battery of claim 1, wherein the compound comprising 60 mol % or greater of Ni is represented by Chemical Formula 7:
LiₐNiₓCo_{y}Me_{z}O₂ [Chemical Formula 7]
wherein, in Chemical Formula 7, 0.9≤a≤1.1, 0.6≤x≤0.98, 0<y≤0.3, 0<z≤0.3, x+y+z=1, and
Me is Mn or Al.
